(19) United States
(12) Patent Application Publication
(10) Pub. No.: US 2017/0302851 A1
(43) Pub. Date: Oct. 19, 2017

(54) A Method and System to Adjust the Camera Frame Rate Based on the Remaining Memory Capacity

(71) Applicant: JRD Communication Inc., Shenzhen (CN)

(72) Inventors: Bin Yu, Shenzhen (CN); Weiqin Yang, Shenzhen (CN)

(73) Assignee: JRD Communication Inc., Shenzhen (CN)

(21) Appl. No.: 15/323,957

(22) PCT Filed: May 18, 2016
(86) PCT No.: PCT/CN2016/082520

§ 371 Date: Jan. 4, 2017

(30) Foreign Application Priority Data
Sep. 17, 2015 (CN) 201510592430.1

(51) Int. Cl. H04N 5/232; G06F 9/50

(52) U.S. Cl. CPC H04N 5/23232; H04N 5/23216; G06F 9/5016; G06F 9/505

(57) ABSTRACT

A method and system is described to adjust a camera frame rate based on remaining memory capacity, which is used to determine a remaining memory capacity scope in which a current remaining memory capacity belongs; find a frame rate corresponding to said remaining memory capacity scope, and adjust the camera frame rate to the frame rate corresponding to said remaining memory capacity. Thus, when there is any change in a remaining memory capacity because memory is taken up by other features, a frame rate of a camera output image may be automatically adjusted according to the change in the remaining memory capacity.

### TECHNICAL FIELD

The present disclosure relates to the field of mobile terminal technology, in particular to a method and system to adjust the camera frame rate based on the remaining memory capacity.

### BACKGROUND

Currently, the camera function is one of the common features on the mobile terminal such as a mobile phone, and in order to enable camera preview, both the number of pixels and the frame rate of the camera are high; as a result, the camera passes considerable data to the main controller in a short time, while processing capability of the main controller is limited, so the data needs to be temporarily stored in the memory. When the remaining memory capacity is low (e.g. quite a lot of memory is taken up when the user carries out downloading and other functions at the same time), there will be nowhere to store the data passed from the camera; this will affect the use of the camera, and the impacts range from jamming of the camera to a crash of the mobile terminal.

Thus, the prior art has to be improved and enhanced.

### SUMMARY

In light of the deficiencies of the prior art, a method and system is provided to adjust the camera frame rate based on the remaining memory capacity, which can solve problems ranging from jamming of the camera to crash of the mobile terminal when the remaining memory capacity is low.

In an embodiment, a method to adjust a camera frame rate based on a remaining memory capacity, comprising:

presetting a plurality of frame rates for adjusting the camera frame rate and a plurality of remaining memory capacity scopes for determining a scope of the remaining memory capacity; set corresponding relations between said plurality of remaining memory capacity scopes and said plurality of frame rates; and preset an upper limit and a lower limit for the remaining memory capacity;

detecting a current remaining memory capacity, and determine a remaining memory capacity scope in which the current remaining memory capacity belongs; and

according to the remaining memory capacity scope in which said remaining memory capacity belongs, finding a preset frame rate from the preset plurality of frame rates corresponding to said remaining memory capacity scope, and adjust the camera frame rate to the preset frame rate corresponding to said remaining memory capacity;

updating thresholds corresponding to said remaining memory capacity scope to the upper limit and the lower limit for detecting the remaining memory capacity.

In a further embodiment, the method further includes: wherein said presetting comprises:

Set N+1 thresholds used to determine the plurality of remaining memory capacity scopes, i.e. T_0, T_1, T_2, T_3, . . . T_N−1, and T_N, in which, 0≦T_0≦T_1≦T_2≦T_3≦ . . . ≦T_N−1≦T_N≦TMAX, and TMAX is a total memory capacity;

When setting the plurality of remaining memory capacity scopes, treat an interval between two adjacent thresholds as one remaining memory capacity scope, i.e. treat an interval [T_0, T_1) as one remaining memory capacity scope R_1, an interval [T_1, T_2) as one remaining memory capacity scope R_2, an interval [T_2, T_3) as one remaining memory capacity scope R_3, . . . , an interval [T_N−2, T_N−1) as one remaining memory capacity scope R_N−1, and an interval [T_N−1, T_N)as one remaining memory capacity scope R_N, so as to determine N remaining memory capacity scopes;

Set N frame rates as the plurality of frame rates used to adjust the camera frame rate, i.e. F_1, F_2, F_3, . . . , F_N−1, and F_N, in which, 0<F_1≦F_2≦F_3≦ . . . ≦F_N−1≦F_N;

Set corresponding relations between the plurality of remaining memory capacity scopes and the plurality of frame rates, wherein said corresponding relations are as follows:

When scope of the remaining capacity is R_1, the frame rate is F_1;

When scope of the remaining capacity is R_2, the frame rate is F_2;

When scope of the remaining capacity is R_3, the frame rate is F_3;

. . . ,

When scope of the remaining capacity is R_N−1, the frame rate is F_N−1;,

When scope of the remaining capacity is R_N, the frame rate is F_N.

In yet a further embodiment, the method further includes: wherein the detecting of the current remaining memory capacity comprises:

detecting the remaining memory capacity, and compare the remaining memory capacity with the upper limit and the lower limit preset for the remaining memory capacity;

when the remaining memory capacity is greater than the upper limit or smaller than the lower limit, acquire the remaining memory capacity;

According to said remaining memory capacity, determine the remaining memory capacity scope to which said remaining memory capacity belongs.

In an embodiment, a method to adjust a camera frame rate based on a remaining memory capacity is provided, which may include:

presetting a plurality of frame rates for adjusting the camera frame rate and a plurality of remaining memory capacity scopes for determining a scope of the remaining memory capacity; and set corresponding relations between said plurality of remaining memory capacity scopes and said plurality of frame rates;

detecting a current remaining memory capacity, and determine a remaining memory capacity scope in which the current remaining memory capacity belongs; and

according to the remaining memory capacity scope in which said remaining memory capacity belongs, finding a preset frame rate from the preset plurality of frame rates corresponding to said remaining memory capacity scope, and adjust the camera frame rate to the preset frame rate corresponding to said remaining memory capacity.

In a further embodiment, the method further includes: wherein said presetting comprises:

Set N+1 thresholds used to determine the plurality of remaining memory capacity scopes, i.e. T_0, T_1, T_2, T_3, T_N−1, and T_N, in which, 0≦T_0≦T_1≦T_2≦T_3≦ . . ≦T_N−1≦T_N≦TMAX, and TMAX is a total memory capacity;

When setting the plurality of remaining memory capacity scopes, treat an interval between two adjacent thresholds as one remaining memory capacity scope, i.e. treat an interval [T_0, T_1) as one remaining memory capacity scope R_1, an interval [T_1, T_2) as one remaining memory capacity scope R_2, an interval [T_2, T_3) as one remaining memory capacity scope R_3, . . . , an interval [T_N−2, T_N−1) as one remaining memory capacity scope R_N−1, and an interval [T_N−1, T_N) as one remaining memory capacity scope R_N, so as to determine N remaining memory capacity scopes:

Set N frame rates as the plurality of frame rates used to adjust the camera frame rate, i.e. F_1, F_2, F_3, F_N−1, and F_N, in which, 0<F_1≦F_2≦F_3≦ . . . ≦F_N−1≦F_N;

Set corresponding relations between the plurality of remaining memory capacity scopes and the plurality of frame rates, wherein said corresponding relations are as follows:

When scope of the remaining capacity is R_1, the frame rate is F_1;

When scope of the remaining capacity is R_2, the frame rate is F_2;

When scope of the remaining capacity is R_3, the frame rate is F_3;

. . . ;

When scope of the remaining capacity is R_N−1, the frame rate is F_N−1;

When scope of the remaining capacity is R_N, the frame rate is F_N.

In yet a further embodiment, the method further includes: presetting an upper limit and a lower limit for the remaining memory capacity.

In yet a further embodiment, the method further includes:

wherein the detecting comprises:

detecting the remaining memory capacity, and compare the remaining memory capacity with the upper limit and the lower limit preset for the remaining memory capacity;

when the remaining memory capacity is greater than the upper limit or smaller than the lower limit, acquire the remaining memory capacity;

According to said remaining memory capacity, determine the remaining memory capacity scope to which said remaining memory capacity belongs.

In yet a further embodiment, the method further includes: wherein the finding the preset frame rate comprises:

according to the corresponding relations between the plurality of remaining memory capacity scopes and the plurality of frame rates, find the preset frame rate corresponding to said remaining memory capacity, and adjust the camera frame rate to said preset frame rate;

Update the thresholds corresponding to said remaining memory capacity scope to the upper limit and the lower limit for detecting the remaining memory capacity.

In an embodiment, a system to adjust a camera frame rate based on a remaining memory capacity is provided, which may include one or more modules configured to:

preset a plurality of frame rates for adjusting the camera frame rate, a plurality of remaining memory capacity scopes for determining a scope of the remaining memory capacity, and the corresponding relations between said plurality of remaining memory capacity scopes and said plurality of frame rates;

detect a current remaining memory capacity, and determine a remaining memory capacity scope in which the current remaining memory capacity belongs;

according to the remaining memory capacity scope in which said remaining memory capacity belongs, find the preset frame rate corresponding to said remaining memory capacity scope, and adjust the camera frame rate to the frame rate corresponding to said remaining memory capacity.

In a further embodiment, said presetting may include:

setting N+1 thresholds used to determine the plurality of remaining memory capacity scopes, i.e. T_0, T_1, T_2, T_3, T_N−1, and T_N, in which, 0≦T_0 ≦T_1≦T_2≦T_3≦ . . . ≦T_N−1≦T_N≦TMAX, and TMAX is the total memory capacity;

setting the plurality of remaining memory capacity scopes, by treating an interval between two adjacent thresholds as one remaining memory capacity scope, i.e. treating an interval [T_0, T_1) as one remaining memory capacity scope R_1, an interval [T_1, T_2) as one remaining memory capacity scope R_2, an interval [T_2, T_3) as one remaining memory capacity scope R_3, . . . , an interval [T_N−2, T_N−1) as one remaining memory capacity scope R_N−1, and an interval [T_N−1, T_N) as one remaining memory capacity scope R_N, so as to determine N remaining memory capacity scopes;

setting N frame rates as the plurality of frame rates used to adjust the camera frame rate, i.e. F_1, F_2, F_3, . . . F_N−1, and F_N, in which, 0<F_1≦F_2≦F_3≦ . . . ≦F_1 ≦F_N;

setting corresponding relations between the plurality of remaining memory capacity scopes and the plurality of frame rates, wherein said corresponding relations are as follows:

When scope of the remaining capacity is R_1, the frame rate is F_1;

When scope of the remaining capacity is R_2, the frame rate is F_2;

When scope of the remaining capacity is R_3, the frame rate is F_3;

. . . ;

When scope of the remaining capacity is R_N−1, the frame rate is F_N−1;

When scope of the remaining capacity is R_N, the frame rate is F_N.

In yet a further embodiment, the presetting may include: presetting an upper limit and a lower limit for the remaining memory capacity.

In yet a further embodiment, the detecting may include:

detecting the remaining memory capacity, and to compare the remaining memory capacity with the upper limit and the lower limit preset for the remaining memory capacity;

acquiring the remaining memory capacity when the remaining memory capacity is greater than the upper limit or smaller than the lower limit;

determining the remaining memory capacity scope to which said remaining memory capacity belongs, according to said remaining memory capacity.

In yet a further embodiment, the finding the preset frame rate may include:

wherein the finding the preset frame rate comprises: according to the corresponding relations between the plurality of remaining memory capacity scopes and the plurality of frame rates, find the preset frame rate corresponding to said remaining memory capacity, and adjust the camera frame rate to said preset frame rate;

update the thresholds corresponding to said remaining memory capacity scope to the upper limit and the lower limit for detecting the remaining memory capacity.

The method and system to adjust the camera frame rate based on the remaining memory capacity thus includes: detect the current remaining memory capacity, determine the remaining memory capacity scope to which the current remaining memory capacity belongs, according to the remaining memory capacity scope to which said remaining memory capacity belongs, find the preset frame rate corresponding to said remaining memory capacity scope, and adjust the camera frame rate to the frame rate corresponding to said remaining memory capacity. In the present invention, the remaining memory capacity is divided into multiple scopes, and these scopes are corresponding multiple frame rates, while the corresponding frame rate is found according to the remaining memory capacity scope to which the detected remaining memory capacity belongs, and the camera is adjusted to said frame rate; when there is any change in the remaining memory capacity because the memory is taken up by other features, the frame rate of the camera output image will be automatically adjusted according to the change in the remaining memory capacity, so as to advantageously avoid problems ranging from jamming of the camera to crash of the mobile terminal caused by low remaining memory capacity in the prior art.

### BRIEF DESCRIPTION OF THE DRAWINGS

FIG. 1 depicts a flow chart of a method to adjust the camera frame rate based on the remaining memory capacity according to a preferred exemplary embodiment of the present invention.

FIG. 2 depicts a flow chart showing Block S1 used in the method to adjust the camera frame rate based on the remaining memory capacity according to an exemplary embodiment of the present invention.

FIG. 3 depicts a flow chart showing Block S2 used in the method to adjust the camera frame rate based on the remaining memory capacity according to an exemplary embodiment of the present invention.

FIG. 4 depicts a flow chart showing Block S3 used in the method to adjust the camera frame rate based on the remaining memory capacity according to an exemplary embodiment of the present invention.

FIG. 5 depicts a schematic structure diagram showing a system to adjust the camera frame rate based on the remaining memory capacity according to an exemplary embodiment of the present invention.

### DETAILED DESCRIPTION

The present invention provides a method and system to adjust the camera frame rate based on the remaining memory capacity; in order to have a clearer understanding of the purpose, technical solution and effect of the present invention, Figures and Embodiments are referred as follows to further specify the present invention. It should be understood that the specific Embodiments described herein are only intended to illustrate the present invention, not to limit the present invention.

In the following, Figures and Embodiments are combined and described to further specify the content of the present invention.

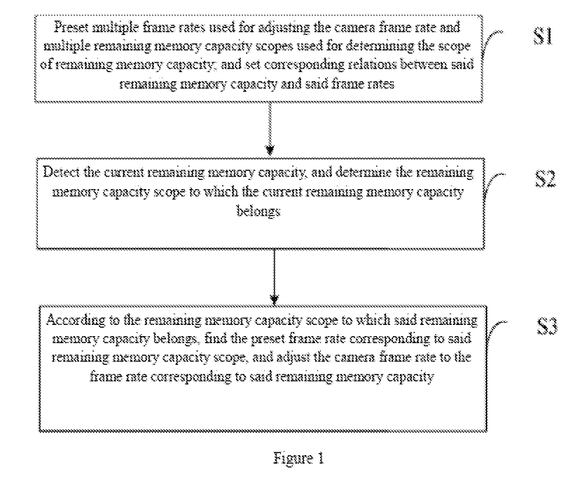

See FIG. 1, which is a flow chart of a preferred Embodiment showing the method to adjust the camera frame rate based on the remaining memory capacity as specified in the present invention. As shown in FIG. 1, said method may include:

Preset multiple frame rates used for adjusting the camera frame rate, multiple remaining memory capacity scopes used for determining the scope of remaining memory capacity, and corresponding relations between said remaining memory capacity scopes and said frame rates. (Block S1)

In Block 51, said remaining memory capacity may be the unused memory size, which is equivalent to the result in bytes by subtracting the used memory size from the total system memory size. That is to say, the remaining memory capacity scope specified herein is a numerical interval indicating a byte range, e.g. when the remaining memory capacity scope is [20, 60), it means the remaining memory capacity is between 20 bytes and 60 bytes, including 20, excluding 60.

The number of said preset frame rates may be equivalent to the number of the preset remaining memory capacity scopes, in which these numbers can be set according to the camera memory size as well as the size of one frame of camera data, and they can be preset in the system, so as to ensure consistent adjustment every time when the camera function is used. Alternatively, these numbers can be preset into multiple different values, in which, the users themselves can make the setting according to the current use state of the mobile terminal, so as to allow less finding attempts and higher work efficiency of the system.

Detect the current remaining memory capacity, and determine the remaining memory capacity scope to which the current remaining memory capacity belongs; (Block S2) in Block S2, before detecting the current remaining memory capacity, it can include a process to judge whether the detection function is started, in which, if the detection function is started, the remaining memory capacity can be detected, and if not started, the judgment operation will be terminated. The users themselves can choose to set the judgment function according to their needs.

According to the remaining memory capacity scope to which said remaining memory capacity belongs, find the preset frame rate corresponding to said remaining memory capacity scope, and adjust the camera frame rate to the frame rate corresponding to said remaining memory capacity. (Block S3)

The remaining memory capacity may be divided into multiple scopes, and these scopes are corresponding to multiple frame rates, while the corresponding frame rate is found according to the remaining memory capacity scope to which the detected remaining memory capacity belongs, and the camera is adjusted to said frame rate; when there is any change in the remaining memory capacity because the memory is taken up by other features, the frame rate of the camera output image will be automatically adjusted according to the change in the remaining memory capacity, so as to avoid problems ranging from jamming of the camera to crash of the mobile terminal caused by low remaining memory capacity in the prior art.

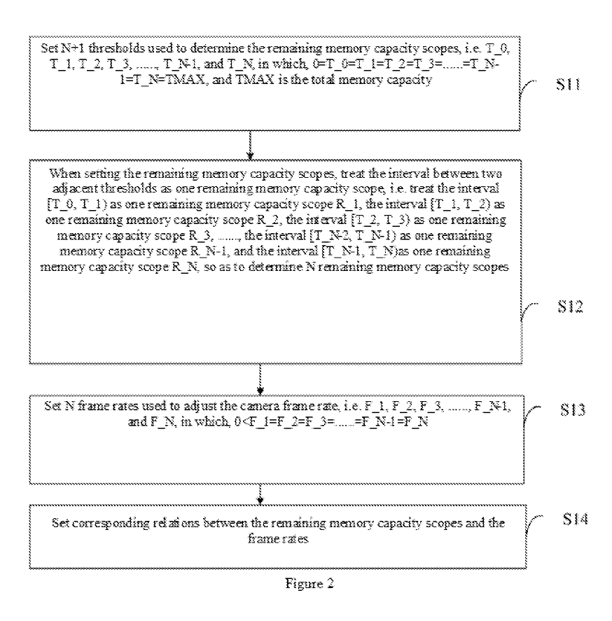

In an Embodiment, as shown in FIG. 2, details of Block S1 are as follows:

S11: Set N+1 thresholds used to determine the remaining memory capacity scopes, i.e. T_0, T_1, T_2, T_3, T_N−1, and T_N, in which, 0≦T_0≦T_1≦T_2≦T_3≦ . . . ≦T_N−1≦T_N≦TMAX, and TMAX is the total memory capacity;

Specifically, set N+1 thresholds, in which, N is a positive integer. Each threshold is expressed in bytes, e.g. T_1 indicates T_1 bytes. The thresholds are an increasing sequence of numbers, in which, said increasing sequence of numbers are an increasing sequence of numbers in equal proportion and equal increment, or an increasing arithmetic sequence, or an irregular increasing sequence. They can be chosen according to the memory read-and-write speed as well as the size of one frame of the camera data, or they can be set arbitrarily, while no limit is put herein for this aspect. An example is given as follows for illustration only, e.g. set 5 thresholds, namely:

T_0=0 Mb,

T_1=1 Mb,

T_2=2 Mb,

T_3=50 Mb,

T_4=10 Gb;

In which, Mb means 1,000 bytes, and Gb means 1,000,000 bytes.

When setting the remaining memory capacity scopes, treat the interval between two adjacent thresholds as one remaining memory capacity scope, i.e. treat the interval [T_0, T_1) as one remaining memory capacity scope R_1, the interval [T_1, T_2) as one remaining memory capacity scope R_2, the interval [T_2, T_3) as one remaining memory capacity scope R_3, the interval [T_N−2, T_N−1) as one remaining memory capacity scope R_N−1, and the interval [T_N−1, T_N)as one remaining memory capacity scope R_N, so as to determine N remaining memory capacity scopes. (Block S12)

Specifically, the value of N as specified in N remaining memory capacity scopes is the same as the value of N as specified in the preset N+1 thresholds, which means, N remaining memory capacity scopes are constituted by the preset N+1 thresholds. e.g. the interval [T_0, T_1) constituted by the thresholds T_0 and _1 is one remaining memory capacity scope. If the remaining memory capacity belongs to the remaining memory capacity scope [T_0, T_1), that means the remaining memory capacity is between T_0 bytes and T_1 bytes, and number of bytes of the remaining memory capacity is greater than T_0 and smaller than T_1. For example, when the thresholds are T_0=0 Mb, T_1=1 Mb, T_2=2 Mb, T_3=50 Mb and T_4=10 Gb, they constitute 4 remaining memory capacity scopes, namely R_1, R_2, R_3 and R_4, and details are as follows:

R_1=[T_0, T_1)=[0 Mb, 1 Mb);

R_2=[T_1, T_2)=[1 Mb, 2 Mb);

R_3=[T_2, T_3)=[2 Mb, 50 Mb);

R_4=[T_3, T_4)=[50 Mb, 1010 Gb).

A frame rate setting module, used for setting N frame rates used to adjust the camera frame rate, i.e. F_1, F_2, F_3, F_N−1, and F_N, in which, 0<F_1≦F_2≦F_3. . . ≦F_{—N-}1≦F_N. (Block S13)

Specifically, the value of N as specified in N frame rates is the same as the value of N as specified in the preset N+1 thresholds. The value of the frame rates can be chosen according to the processing speed of the camera as well as the size of one frame of the camera data, or they can be set by the users themselves, while no limit is put herein for this aspect. An example is given as follows for illustration only, e.g. set 4 frame rates, namely:

F_1=5 fps,

F_2=8 fps,

F_3=16 fps,

F_4=30 fps.

Set corresponding relations between the remaining memory capacity scopes and the frame rates, and said corresponding relations are as follows:

When scope of the remaining capacity is R_1, the frame rate is F_1;

When scope of the remaining capacity is R_2, the frame rate is F_2;

When scope of the remaining capacity is R_3, the frame rate is F_3;

. . . ;

When scope of the remaining capacity is R_N−1, the frame rate is F_N−1;

When scope of the remaining capacity is R_N, the frame rate is F_N. (Block S14)

For example, when R_1=[0 Mb, 1 Mb), R_2=[1 Mb, 2 Mb), R_3=[2 Mb, 50 Mb) and R_4=[50 Mb, 10 Gb); F_1=5 fps, F_2=8 fps, F_3=16 fps, and F_4=30 fps; then,

R_1=[0 Mb, 1 Mb) corresponds to F_1=5 fps;

R_2=[1 Mb, 2 Mb) corresponds to F_2=8 fps;

R_3=[2 Mb, 50 Mb) corresponds to F_3=16 fps;

R_4=[50 Mb, 10 Gb) corresponds to F_4=30 fps.

In which, fps is a unit of the frame rate, indicating frames per second.

More specifically, said Block S1 may further include: preset the upper limit and the lower limit for the remaining memory capacity.

Said upper limit and said lower limit are initial values of the system, in which, they can be set to any positive integer smaller than the total memory size, preferably the last two thresholds, i.e. T_N−0, T_N and T_N−1 are initial values for the lower limit, and T_N is the initial value for the upper limit. Said upper limit and said lower limit are used to judge whether there is any need to adjust the camera frame rate considering the current remaining memory capacity. More specifically, after each adjustment, said upper limit and said lower limit will be updated to the endpoint values in the remaining memory capacity scope corresponding to this camera working frame.

In an Embodiment, as shown in FIG. 3, Block S2 may include:

Detect the remaining memory capacity, and compare the remaining memory capacity with the upper limit and the lower limit preset for the remaining memory capacity; (Block S21)

Specifically, in said detecting of the remaining memory capacity, the trigger mode can be adopted to acquire the size of the remaining memory capacity, i.e. preset one upper limit for the remaining memory capacity and one lower limit for the remaining memory capacity, compare the remaining memory capacity acquired by detecting with the preset upper limit and the preset lower limit, and according to the comparison result, judge whether to acquire the remaining memory capacity. That is to say, before adjusting of the frame rate according to the remaining memory capacity, it includes a detection process, which allows detecting whether the current remaining memory capacity is within the remaining memory capacity scope corresponding to the executing frame rate, and according to the detection result, it will be judged whether to acquire the remaining memory capacity and to carry out the frame rate adjustment; it provides a prejudgment process, and according to the result of such prejudgment process, it can be chosen whether to carry out the frame rate adjustment, so as to allow higher work efficiency of the mobile device.

If the remaining memory capacity is greater than the upper limit or smaller than the lower limit, acquire the remaining memory capacity. (Block S22)

Specifically, if the remaining memory capacity is greater than the upper limit or smaller than the lower limit, acquire the remaining memory capacity, and continue to adjust the camera frame rate; if the remaining memory capacity is greater than the lower limit and smaller than the upper limit, that means the current remaining memory capacity is within the remaining memory capacity scope corresponding to the current executing frame rate, so there is no need to adjust the camera frame rate, and the adjustment operation is terminated.

According to said remaining memory capacity, determine the remaining memory capacity scope to which said remaining memory capacity belongs. (Block S23)

In the above Embodiment, before acquiring of the remaining memory capacity, the comparison and analysis of the remaining memory capacity with the preset upper limit and lower limit may be detected, and according to the result of such comparison and analysis, it will be determined whether to carry out next steps in adjustment of the camera frame rate, in which, it provides a prejudgment process, and according to the result of such prejudgment process, it can be chosen whether to carry out the frame rate adjustment, so as to allow higher work efficiency of the mobile device as well as energy saving.

In an Embodiment, as shown in FIG. 4, Block S3 may include: According to the corresponding relations between the remaining memory capacity scopes and the frame rates, find the frame rate corresponding to said remaining memory capacity, and adjust the camera frame rate to said frame rate; (Block S31) Update the thresholds corresponding to said remaining memory capacity scope to the upper limit and the lower limit for detecting the remaining memory capacity. (Block S32)

Blocks S31 and S32 may thus include: determine the remaining memory capacity scope corresponding to the current remaining memory capacity, adjust the camera frame rate to the frame rate corresponding to said remaining memory capacity scope, and then, replace the upper limit and lower limit with the endpoint values of said remaining memory capacity, in which, they are used as a basis to determine whether to acquire the remaining memory capacity next time when the camera frame rate is adjusted.

For example, if the upper limit is expressed as ah, and the lower limit is expressed as al, adjust the remaining memory capacity scope corresponding to the frame rate to R_3=[2 Mb, 50 Mb), and after adjusting of the frame rate, replace ah and al with the endpoint values in R_3=[2 Mb, 50 Mb). That is to say, ah is updated to 50 Mb, and al is updated to 2 Mb.

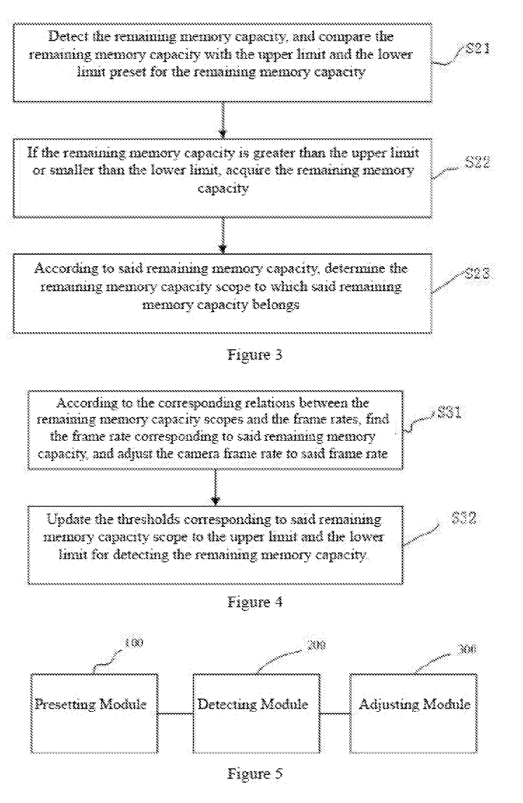

The present invention also provides a system to adjust the camera frame rate based on the remaining memory capacity, and as shown in FIG. 5, said system may include:

A presetting module 100, used to preset: multiple frame rates used for adjusting the camera frame rate, multiple remaining memory capacity scopes used for determining the scope of remaining memory capacity, and the corresponding relations between said remaining memory capacity scopes and said frame rates;

A detecting module 200, used to detect the current remaining memory capacity, and to determine the remaining memory capacity scope to which the current remaining memory capacity belongs;

An adjusting module 300, used to, according to the remaining memory capacity scope to which said remaining memory capacity belongs, find the preset frame rate corresponding to said remaining memory capacity scope, and adjust the camera frame rate to the frame rate corresponding to said remaining memory capacity.

The system to adjust the camera frame rate based on the remaining memory capacity can be set inside the main controller, while said controller is connected to the camera, in which, the main controller sends configuration commands to the camera, so as to adjust the frame rate of the camera output image; according to the commands sent by the main controller, the camera adopt the corresponding frame rate to output the image data sensed by said camera to the main controller; said main controller is also connected to the memory, in which, the main controller acquires the remaining memory capacity and determines the remaining memory capacity scope to which the current remaining memory capacity belongs; according to the remaining memory capacity scope to which said remaining memory capacity belongs, find the preset frame rate corresponding to said remaining memory capacity scope, and adjust the camera frame rate to the frame rate corresponding to said remaining memory capacity.

More specifically, in said system used to adjust the camera frame rate based on the remaining memory capacity, said presetting module may further include:

A threshold setting module, used for setting N+1 thresholds used to determine the remaining memory capacity scopes, i.e. T_0, T_1, T_2, T_3, . . . , T_N−1, and T_N, in which, 0≦T_0 m2≦T_3≦ . . . ≦T _N−1≦T_N≦TMAX, and TMAX is the total memory capacity;

A scope setting module, used for setting the remaining memory capacity scopes, by treating the interval between two adjacent thresholds as one remaining memory capacity scope, i.e. treating the interval [T_0, T_1) as one remaining memory capacity scope R_1, the interval [T_1, T_2) as one remaining memory capacity scope R_2, the interval [T_2, T_3) as one remaining memory capacity scope R_3, the interval [T_N−2, T_N−1) as one remaining memory capacity scope R_N−1, and the interval [T_N−1, T_N)as one remaining memory capacity scope R_N, so as to determine N remaining memory capacity scopes;

A frame rate setting module, used for setting N frame rates used to adjust the camera frame rate, i.e. F_1, F_2, F_3, F_N−1, and F_N, in which, 0<F_1≦F_2≦F_3≦ . . . ≦F_N−1,F_N;

A corresponding relations setting module, used for setting corresponding relations between the remaining memory capacity scopes and the frame rates, and said corresponding relations are as follows:

When scope of the remaining capacity is R_1, the frame rate is F_1;

When scope of the remaining capacity is R_2, the frame rate is F_2;

When scope of the remaining capacity is R_3, the frame rate is F_3;

. . . ;

When scope of the remaining capacity is R_N−1, the frame rate is F_N−1;

When scope of the remaining capacity is R_N, the frame rate is F_N;

In said system used to adjust the camera frame rate based on the remaining memory capacity, said presetting module may further include:

A setting module, used to preset the upper limit and the lower limit for the remaining memory capacity.

In said system used to adjust the camera frame rate based on the remaining memory capacity, said detecting module may further include:

A comparison module, used to detect the remaining memory capacity, and to compare the remaining memory capacity with the upper limit and the lower limit preset for the remaining memory capacity;

An acquiring module, used to acquire the remaining memory capacity when the remaining memory capacity is greater than the upper limit or smaller than the lower limit;

A determining module, used to, according to said remaining memory capacity, determine the remaining memory capacity scope to which said remaining memory capacity belongs.

Specifically, said comparison module may comprise two comparators, namely the first comparator and the second comparator, in which, two input terminals of the first comparator are respectively connected to the memory and the upper limit preset for the remaining memory capacity; when the remaining memory capacity changes from a state equivalent to or smaller than the upper limit for the remaining memory capacity to a state greater than the upper limit for the remaining memory capacity, the output terminal of the first comparator will output a signal to trigger the acquiring module. Two input terminals of the second comparator are respectively connected to the memory and the lower limit preset for the remaining memory capacity; when the remaining memory capacity changes from a state equivalent to or greater than the upper limit for the remaining memory capacity to a state smaller than the lower limit for the remaining memory capacity, the output terminal of the second comparator will output a signal to trigger the acquiring module. It should be noted that the acquiring module will acquire the remaining memory capacity as long as the output terminal of any one of the first comparator and the second comparator outputs a signal to trigger the acquiring module.

In said system used to adjust the camera frame rate based on the remaining memory capacity, said adjusting module may further include:

An execution module, used to, according to the corresponding relations between the remaining memory capacity scopes and the frame rates, find the frame rate corresponding to said remaining memory capacity, and adjust the camera frame rate to said frame rate;

An updating module, used to update the thresholds corresponding to said remaining memory capacity scope to the upper limit and the lower limit for detecting the remaining memory capacity.

Accordingly, unit modules in the system to adjust the camera frame rate based on the remaining memory capacity have been described.

The abovementioned system to adjust the camera frame rate based on the remaining memory capacity shares the same idea with the method to adjust the camera frame rate based on the remaining memory capacity as specified in the above Embodiment, and in said system to adjust the camera frame rate based on the remaining memory capacity, it is possible to operate any one of modes as provided in the Embodiment showing the method to adjust the camera frame rate based on the remaining memory capacity, while details to do so can be found in said Embodiment showing the method to adjust the camera frame rate based on the remaining memory capacity.

It should be noted that, in terms of the method to adjust the camera frame rate based on the remaining memory capacity as provided in the Embodiment of the present invention, those skilled in the art can understand all or part of the process in the method to adjust the camera frame rate based on the remaining memory capacity of the method as provided in the Embodiment of the present invention, and they can complete the process by controlling relevant hardware through a computer program, in which, said computer program can be stored in a computer readable storage medium, e.g. stored in the memory of the mobile terminal, and executed by at least one of processors in said mobile terminal, and in the execution process, it can include the process as specified in the Embodiment showing the above modes. Said storage medium can be magnetic disk, CD, read-only memory (ROM) or random access memory (RAM) and the like.

In terms of the system to adjust the camera frame rate based on the remaining memory capacity as provided in the Embodiment of the present invention, its functional modules can be integrated in one processing chip, and alternatively, they can exist physically and separately, or two or more of them can be integrated in one module. Said integrated modules can be achieved in the form of hardware or in the form of software function modules. When said integrated modules is achieved in the form of software function modules and sold and used as stand-alone products, they can be stored in a computer readable storage medium, in which, said computer readable storage medium can be read-only memory, magnetic disk or CD or the like.

It should be understood that those skilled in the art can make equivalent replacements or changes according to the technical solution and its invention concept as specified in the present invention, and all these changes or replacements should belong to the protection scope as provided in the claims appended herein.

1. A method to adjust a camera frame rate based on a remaining memory capacity, comprising:
presetting a plurality of frame rates for adjusting the camera frame rate and a plurality of remaining memory capacity scopes for determining a scope of the remaining memory capacity; set corresponding relations between said plurality of remaining memory capacity scopes and said plurality of frame rates; and preset an upper limit and the a lower limit for the remaining memory capacity;
detecting a current remaining memory capacity, and determine a remaining memory capacity scope in which the current remaining memory capacity belongs; and
according to the remaining memory capacity scope in which said remaining memory capacity belongs, finding a preset frame rate from the preset plurality of frame rates corresponding to said remaining memory capacity scope, and adjust the camera frame rate to the preset frame rate corresponding to said remaining memory capacity;
updating thresholds corresponding to said remaining memory capacity scope to the upper limit and the lower limit for detecting the remaining memory capacity.

2. The method of claim 1,
wherein said presetting comprises:
Set N+1 thresholds used to determine the plurality of remaining memory capacity scopes, i.e. T_0, T_1, T_2, T_3, . . . T_N−1, and T_N, in which, 0≦T_0≦T_1≦T_2≦T_3≦ . . . ≦T_N−1, and T_N, in which, and TMAX is a total memory capacity;
When setting the plurality of remaining memory capacity scopes, treat an interval between two adjacent thresholds as one remaining memory capacity scope, i.e. treat an interval [T_0, T_1) as one remaining memory capacity scope R_1, an interval [T_1, T_2) as one remaining memory capacity scope R_2, an interval [T_2, T_3) as one remaining memory capacity scope R_3, . . . an interval [T_N−2, T_N−1) as one remaining memory capacity scope R_N−1, and an interval [T_N-−1, T_N)as one remaining memory capacity scope R_N, so as to determine N remaining memory capacity scopes;
Set N frame rates as the plurality of frame rates used to adjust the camera frame rate, i.e. F_1, F_2, F_3, . . . , F_N−1, and F_N, in which, 0<F_1≦F_2≦F_3≦ . . . ≦F_N−1≦F_N;
Set corresponding relations between the plurality of remaining memory capacity scopes and the plurality of frame rates, wherein said corresponding relations are as follows:
When scope of the remaining capacity is R_1, the frame rate is F_1;
When scope of the remaining capacity is R_2, the frame rate is F_2;
When scope of the remaining capacity is R_3, the frame rate is F_3;
. . . ;
When scope of the remaining capacity is R_N−1, the frame rate is F_N−1;
When scope of the remaining capacity is R_N, the frame rate is F_N.

3. The method of claim 1, wherein the detecting of the current remaining memory capacity comprises:
detecting the remaining memory capacity, and compare the remaining memory capacity with the upper limit and the lower limit preset for the remaining memory capacity;
when the remaining memory capacity is greater than the upper limit or smaller than the lower limit, acquire the remaining memory capacity.

4. A method to adjust a camera frame rate based on a remaining memory capacity, comprising:
presetting a plurality of frame rates for adjusting the camera frame rate and a plurality of remaining memory capacity scopes for determining a scope of the remaining memory capacity; and set corresponding relations between said plurality of remaining memory capacity scopes and said plurality of frame rates;
detecting a current remaining memory capacity, and determine a remaining memory capacity scope in which the current remaining memory capacity belongs; and
according to the remaining memory capacity scope in which said remaining memory capacity belongs, finding a preset frame rate from the preset plurality of frame rates corresponding to said remaining memory capacity scope, and adjust the camera frame rate to the preset frame rate corresponding to said remaining memory capacity.

5. The method of claim 4, wherein said presetting comprises: Set N+1 thresholds used to determine the plurality of remaining memory capacity scopes, i.e. T_0, T_1, T_2, T_3, . . . , T N−1, and T_N, in which, 0≦T_0≦T_1≦T_3≦ . . . ≦T_N−1≦T_N≦TMAX,
and TMAX is a total memory capacity;
When setting the plurality of remaining memory capacity scopes, treat an interval between two adjacent thresholds as one remaining memory capacity scope, i.e. treat an interval [T_0, T_1) as one remaining memory capacity scope R_1, an interval [T_1, T_2) as one remaining memory capacity scope R_2, an interval [T_2, T_3) as one remaining memory capacity scope R_3, . . . ,
an interval [T_N−2, T_N−1) as one remaining memory capacity scope R_N−1, and an interval [T_N−1, T_N) as one remaining memory capacity scope R_N, so as to determine N remaining memory capacity scopes:
Set N frame rates as the plurality of frame rates used to adjust the camera frame rate, i.e. F_1, F_2, F_3, . . . F_N−1,
and F_N, in which, 0<F_1≦F_2<F_3<. . . <F_N−1≦F_N;
Set corresponding relations between the plurality of remaining memory capacity scopes and the plurality of frame rates, wherein said corresponding relations are as follows:
When scope of the remaining capacity is R_1, the frame rate is F_1;
When scope of the remaining capacity is R_2, the frame rate is F_2;
When scope of the remaining capacity is R_3, the frame rate is F_3;
. . . ;
When scope of the remaining capacity is R_N−1, the frame rate is F_N−1;
When scope of the remaining capacity is R_N, the frame rate is F_N;

6. The method of claim 5, further comprising: presetting an upper limit and a lower limit for the remaining memory capacity.

7. The method of claim 6
wherein the detecting comprises:
detecting the remaining memory capacity, and compare the remaining memory capacity with the upper limit and the lower limit preset for the remaining memory capacity;
when the remaining memory capacity is greater than the upper limit or smaller than the lower limit, acquire the remaining memory capacity.

8. The method of claim 4 wherein the finding the preset frame rate comprises: according to the corresponding relations between the plurality of remaining memory capacity scopes and the plurality of frame rates, find the preset frame rate corresponding to said remaining memory capacity, and adjust the camera frame rate to said preset frame rate;
Update the thresholds corresponding to said remaining memory capacity scope to the upper limit and the lower limit for detecting the remaining memory capacity.

9. A system to adjust a camera frame rate based on a remaining memory capacity, comprising one or more modules configured to:
preset a plurality of frame rates for adjusting the camera frame rate, a plurality of remaining memory capacity scopes for determining a scope of the remaining memory capacity, and the corresponding relations between said plurality of remaining memory capacity scopes and said plurality of frame rates;
detect a current remaining memory capacity, and determine a remaining memory capacity scope in which the current remaining memory capacity belongs;
according to the remaining memory capacity scope in which said remaining memory capacity belongs, find the preset frame rate corresponding to said remaining memory capacity scope, and adjust the camera frame rate to the frame rate corresponding to said remaining memory capacity.

10. The system of claim 9, wherein said presetting comprises:
setting N+1 thresholds used to determine the plurality of remaining memory capacity scopes, i.e. T_0, T_1, T_2, T_3, . . . , T_N−1, and T_N, in which, 0≦T_0≦T_2≦T_3≦ . . . ≦T_N−1T_N≦TMAX, and TMAX is the total memory capacity;
setting the plurality of remaining memory capacity scopes, by treating an interval between two adjacent thresholds as one remaining memory capacity scope, i.e. treating an interval [T_0, T_1) as one remaining memory capacity scope R_1, an interval [T_1, T_2) as one remaining memory capacity scope R_2, the an interval [T_2, T_3) as one remaining memory capacity scope R_3, . . . , an interval [T_N−2, T_N−1) as one remaining memory capacity scope R_N−1, and the an interval [T_N−1, T_N) as one remaining memory capacity scope R_N, so as to determine N remaining memory capacity scopes;
setting N frame rates as the plurality of frame rates used to adjust the camera frame rate, i.e. F_1, F_2, F_3, . . . , F_N−1, and F_N, in which, 0<F_1≦F_2≦F_3≦ . . . ≦F_N−1≦F_N;
setting corresponding relations between the plurality of remaining memory capacity scopes and the plurality of frame rates, wherein said corresponding relations are as follows:
When scope of the remaining capacity is R_1, the frame rate is F_1;
When scope of the remaining capacity is R_2, the frame rate is F_2;
When scope of the remaining capacity is R_3, the frame rate is F_3;
. . . ;
When scope of the remaining capacity is R_N−1, the frame rate is F_N−1;
When scope of the remaining capacity is R_N, the frame rate is F_N;

11. The system of claim 10,
wherein said presetting further comprises: presetting an upper limit and a lower limit for the remaining memory capacity.

12. The system of claim 9, wherein the detecting comprises:
detecting the remaining memory capacity, and to compare the remaining memory capacity with the upper limit and the lower limit preset for the remaining memory capacity;
acquiring the remaining memory capacity when the remaining memory capacity is greater than the upper limit or smaller than the lower limit; determining the remaining memory capacity scope to which said remaining memory capacity belongs, according to said remaining memory capacity.

13. The system of claim 9,
wherein the finding the preset frame rate comprises: according to the corresponding relations between the plurality of remaining memory capacity scopes and the plurality of frame rates, find the preset frame rate corresponding to said remaining memory capacity, and adjust the camera frame rate to said preset frame rate;
update the thresholds corresponding to said remaining memory capacity scope to the upper limit and the lower limit for detecting the remaining memory capacity.

14. The method of claim 1, wherein the method is performed by a mobile terminal.

15. The method of claim 14, wherein the mobile terminal includes one or more processors.

16. The method of claim 4, wherein the method is performed by a mobile terminal.

17. The method of claim 16, wherein the mobile terminal includes one or more processors.

18. The system of claim 9, wherein the system comprises a mobile terminal.

19. The system of claim 18, wherein the mobile terminal includes one or more processors.

20. The system of claim 18, wherein the mobile terminal includes a memory.
